(19) United States
(12) Patent Application Publication
(10) Pub. No.: US 2022/0413467 A1
(43) Pub. Date: Dec. 29, 2022

(54) METHOD OF AND APPARATUS FOR MAINTAINING A TRANSPORT SYSTEM

(71) Applicant: Siemens Aktiengesellschaft, Munchen (DE)

(72) Inventor: Marcel Rothering, Nurnberg (DE)

(21) Appl. No.: 17/841,297

(22) Filed: Jun. 15, 2022

(30) Foreign Application Priority Data
Jun. 24, 2021 (EP) 21181494.2

(51) Int. Cl. G05B 19/4155

(52) U.S. Cl. CPC G05B 19/4155; G05B 2219/31276

(57) ABSTRACT

A computer-implemented method of maintaining a transport system in a manufacturing facility including: measuring one or more pose-related properties of a plurality of transportation devices at a plurality of manufacturing stations in the manufacturing facility, at which manufacturing stations one or more workpieces are processed; determining a statistical characteristic for each of the plurality of transportation devices based on the pose-related properties; determining a sequence for maintaining one or more transportation devices based on the statistical characteristics; and optionally performing one or more maintenance procedures based on the sequence.

The present patent document claims the benefit of European Patent Application No. 21181494.2, filed Jun. 24, 2021, which is hereby incorporated by reference in its entirety.

### TECHNICAL FIELD

The present disclosure relates to a transport system, e.g., a conveying system and, more particularly, to a method of maintaining a transport system. The method further relates to a transport system in a manufacturing facility in which workpieces are processed at a plurality of manufacturing stations.

### BACKGROUND

In automobile production, car bodies are transported in fully automatic transport systems, for example, including one or more conveyors. Using the conveyor or other type of transport system the car bodies pass through a body shop, and through a paint shop, e.g., before they are transported to a final assembly line.

The fully automatic conveyor systems, for example in an assembly line, use transportation devices to which the body is fixed as an assembly object. The transportation devices, also known as assembly support, holders or hangers, may be used to transport the assembly objects or workpieces.

In addition to automobile production and assembly processes in the narrower sense, the disclosure may relate to manufacturing facilities in which one or more objects are subject to inspection and/or condition monitoring to determine and assess their actual condition. The workpieces may consequently be any components, parts, devices, machines, operating resources, production resources, subsystems, systems, or functional units that are to be examined and/or maintained, for example, with regard to temperature, vibration, or positional deviations.

The position and orientation of an object, such as a workpiece and/or a transportation device, is summarized in the following under the term “pose”. DIN EN ISO 8373 defines the term “pose” as a combination of position and orientation of an object in three-dimensional space, which is specified as the basic coordinate system. The position of the object may be specified in three coordinates as the distance of its mass point from the origin of the base coordinate system or other reference system. The orientation of the object may be described, for example, by setting up a further coordinate system at its point of mass, for whose coordinate axes an angular offset to the respective axes of the basic coordinate system is specified by three angle specifications. Different poses may be mapped onto one another by translation and rotation.

According to DIN EN 13306 and DIN 31051, maintenance refers to a combination of measures that serve to maintain or restore a functional condition of an object, such as a transportation device, a manufacturing station, and/or a manufacturing facility. One of these measures is the inspection, which is used to determine and assess the actual condition of the object as well as to determine possible causes of impairments. The result of the inspection may be to identify repair measures for the property, which are then carried out. The term “object” here denotes, for example, a component, part, device or subsystem, a functional unit, an operating medium, or a system that may be viewed on its own.

As part of condition monitoring, object conditions are recorded regularly or permanently by measuring and analyzing physical variables. For this purpose, sensor data is processed that is analyzed, for example, in real time. The monitoring of the object condition enables condition-based maintenance.

Both functional failures of objects such as transportation devices in manufacturing facilities and their repair as well as preventive inspection and maintenance work are associated with high costs, because they may lead to a standstill of the respective production section.

### SUMMARY

The scope of the present disclosure is defined solely by the appended claims and is not affected to any degree by the statements within this summary. The present embodiments may obviate one or more of the drawbacks or limitations in the related art.

It is an object of the present disclosure to reduce downtime in a manufacturing facility by maintaining the transport system in the manufacturing facility and to provide a more efficient maintenance by identifying the most relevant and necessary maintenance activities.

According to a first aspect, the object may be achieved by a computer-implemented method of maintaining a transport system in a manufacturing facility. The method includes measuring one or more pose-related properties of a plurality of transportation devices at a plurality of manufacturing stations in the manufacturing facility, at which manufacturing stations one or more workpieces are processed. The method further includes determining a statistical characteristic for each of the plurality of transportation devices based on the pose-related properties. The method further includes determining a sequence for maintaining one or more transportation devices based on the statistical characteristics. The method further may optionally include performing one or more maintenance procedures based on the sequence.

According to a second aspect, the object is achieved by an apparatus, wherein the apparatus may include a processor and a memory. The apparatus is operative to perform at least part of the method acts of any one of the first aspect.

According to a third aspect, the object is achieved by a computer program product including program code, that when executed performs the method acts of any one of the first aspect.

### BRIEF DESCRIPTION OF THE DRAWINGS

FIG. 1 depicts an example of multiple manufacturing stations in a manufacturing facility.

FIG. 2 depicts an example of a deviation in a pose of a transport device due to a workpiece being loaded.

FIG. 3 depicts an example of a displacement and rotation of different transport devices.

FIGS. 4 to 14 depict exemplary method acts according to particular embodiments.

FIG. 15 depicts an example of an apparatus including a processor and a memory.

### DETAILED DESCRIPTION

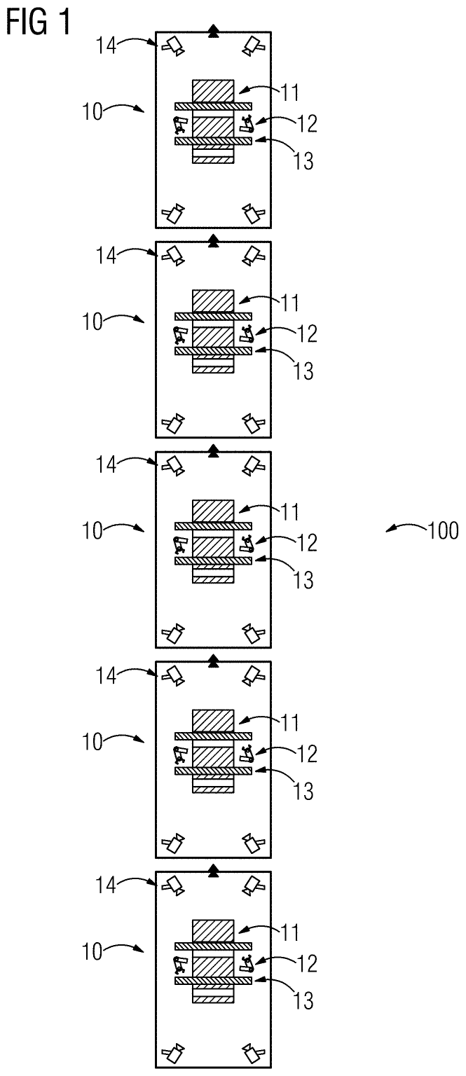

FIG. 1 shows multiple manufacturing stations 10 in a manufacturing facility 100. The manufacturing stations 10 may be combined to form a production line. The production line may thus be formed by multiple manufacturing stations 10 where each manufacturing station 10 performs one or more of a set of sequential operations in order to make a finished article or end-product. In the embodiment according to FIG. 1, car bodies 11 are shown that are transported from one manufacturing station 10 to the next. However, other workpieces (than car bodies 11) may be transported using appropriate transport devices. The workpieces may be processed at the manufacturing stations 10. That is to say, at each manufacturing station 10, one or more manufacturing acts may be performed. For example, underbody painting of a car body may be performed at the manufacturing stations 10. To that end, each manufacturing station 10 includes one or more robots 12 that apply a layer of paint to the underbody of the car body 11. At each station 10, a layer may be applied to the car body 11.

The car bodies 11 are transported to and/or from a manufacturing station 10 by way of one or more transportation devices. In the case of car bodies 11, the transportation devices are hangers 13 in which the car bodies are loaded. The hangers 13 themselves may be attached to a conveyor (not shown) that moves the hangers 13 from one manufacturing station 10 to the next. Other transport devices may include automated guided vehicles.

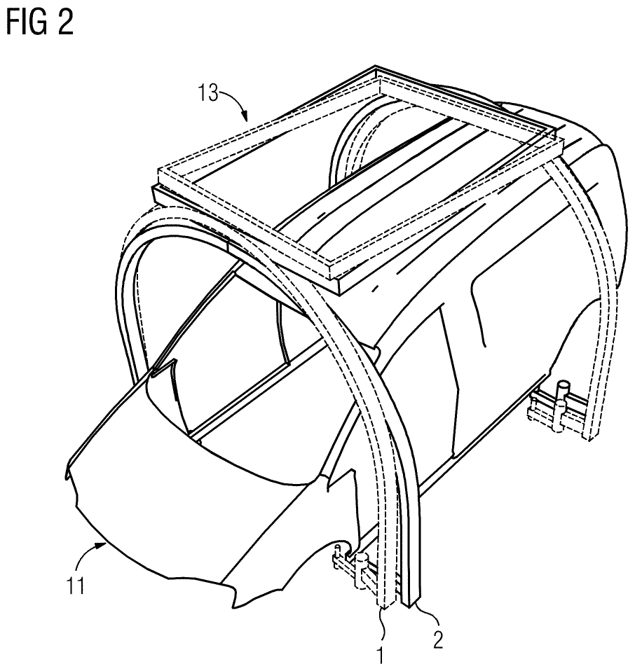

For the processing at a manufacturing station 10 to begin, the pose of the car body 13 and/or the hanger 11 at a manufacturing station 10 needs to be determined. For this purpose, an actual pose of the workpiece in the manufacturing station 10, which indicates its position and/or rotation with respect to a target pose as shown in FIG. 2, is first determined via sensors 14. Such sensors 14 may already be installed in today's manufacturing stations 10, because the sensors 14 allow industrial robots 12 to be fine-tuned. For example, camera-based systems in robot cells, which are passed through manufacturing stations in the context of automobile production, measure the position and rotation of the workpiece fully automatically in each robot cell. To that end, fixed points on the car body may be used by the sensors to determine the pose of the car body. Laser scanners, ultrasound, radar or lidar sensors may also be used. All of the named sensor types provide measured values from which the actual pose of the workpiece may be taken directly or at least calculated. For this purpose, the measured values are stored as raw values or, after suitable processing as sensor data. Such data acquisition in technical systems such as shop floors or manufacturing systems runs continuously in the background in today's industrial cloud applications, so that the corresponding data records only have to be retrieved from the industrial cloud for evaluation. A continuous update of the sensor data, which in turn updates a graphic representation of the sensor data, is advantageously also possible here on the basis of new measurements during operation. If necessary, such updates may even take place in real time.

Turning to FIG. 2, where the deviation in the pose of a transport device due to a workpiece being loaded is illustrated. Here, a hanger 13 is depicted which carries a car body 11. The target pose 1 may be a standardized pose which a manufacturing station to which the workpiece is fed expects and assumes for the workpiece. The target pose 1 may thus form a reference system of the manufacturing station 10. Thus, pose-related properties of the transportation device in a manufacturing station may be determined. The target pose 1 may be predetermined, for example, by a construction of the manufacturing station or it may be measured in advance. An actual pose 2 of the workpiece in the manufacturing station 10, which indicates its displacement and/or rotation with respect to the target pose 1, may be determined via sensors. The actual deviation between the target pose 1 and the actual pose 2 may only be a few millimeters or a very small angular deviation. Such a deviation may be of diagnostic significance in the context of the inspection and/or condition monitoring. The actual pose 2 may therefore calculated based on the sensor data by a processor.

Pose-related properties may thus be obtained in the form of a set of data records, for example, by storing the sensor data once or repeatedly after the respective measurements in a manufacturing station, for example, together with context information. The data records may be continuously updated based on new measurements from the sensors in the one or more manufacturing stations. For example, the context information may include one or more of the following: (1) a point in time of the measurements; (2) a place where the measurements were made, in particular a manufacturing station, such as a robot cell; (3) a type or a serial number of the transportation device, for example a hanger number 81; (4) a type or a serial number of the workpiece, in particular a workpiece loaded, (e.g., mechanically connected), to the transportation device, (e.g., a sedan body with four doors and a hatchback or the like); or (5) a type or a serial number of one of the sensors.

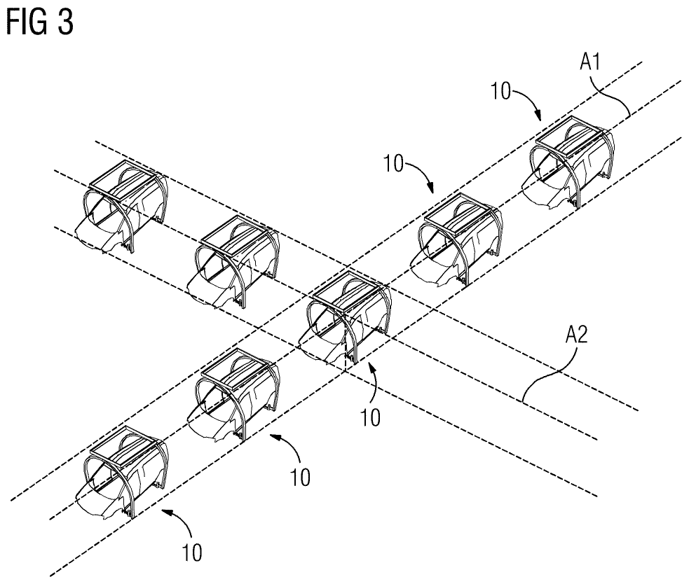

Turning to FIG. 3, for each record of the data records, an actual pose of the respective transportation device, (here the hanger no. 78), is taken or calculated from the respective sensor data (here as variables of the respective robot cell). FIG. 3 illustrates the hanger no. 78 on a first axis A1 in the different manufacturing stations 10 or robot cells. The hanger, or the transportation device in general, may have different deviations from the target pose in the different manufacturing stations.

In addition to the first hanger no. 78, pose-related properties of the hanger nos. 36 and 81, are taken or calculated from the respective sensor data of the respective manufacturing station robot cell. The hangers with nos. 36 and 81, respectively, are identified by references signs 313, 323 in FIG. 3, and shown as on a second axis A2.

Up until now, hangers and transportation devices may be maintained in fixed maintenance cycles regardless of their true quality. It is thus desired to sort the transportation devices and/or to provide a sequence according to their quality. Based on the sorting and/or sequence, a maintenance plan may be created. Critical transport devices may therefore be repaired or discharged at an early stage.

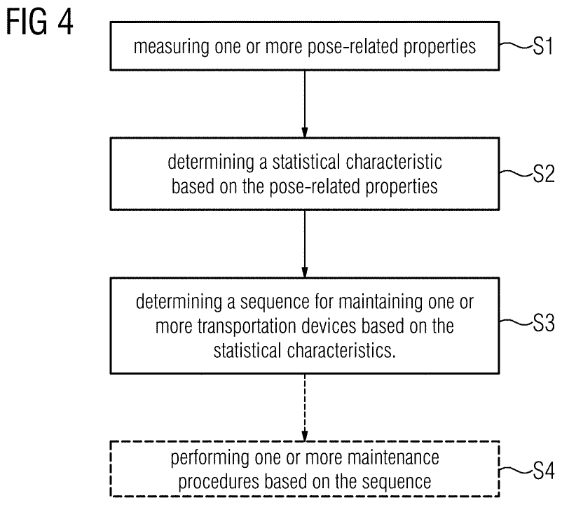

Turning to FIG. 4, exemplary method acts are described. In act S1, one or more pose-related properties of one or more transportation devices are measured. Instead of measuring, the pose-related properties may be obtained from a memory, such as a database, where the pose related properties have been stored. The pose-related properties may be measured at a plurality of manufacturing stations, e.g., in a manufacturing facility. The pose-related properties may be determined for one or more transportation devices, e.g., a plurality of transportation devices. As described in the above, one or more workpieces are processed at the manufacturing station(s).

In act S2, a statistical characteristic for each transportation device of the plurality of transportation devices based on the pose-related properties may be determined. A statistical characteristic, e.g., a distribution, may include a numeric value defined by a statistical measure. The statistical measure may be used to summarize the values for a specific quantitative variable, (e.g., pose-related properties), for all statistical units in a specific group, e.g., one or more transport devices at the one or more manufacturing stations.

In act S3, a sequence for maintaining one or more transportation devices based on the statistical characteristics may be determined. The sequence may be determined based on the values of the statistical characteristic(s). The sequence may be output to a user, e.g., manufacturing facility operator or a maintenance technician. The statistical characteristic(s) and/or the sequence determined may also be depicted in graphical or tabular format, including histograms and stem-and-leaf display.

In act S4, one or more maintenance procedures based on the sequence may be performed. Such maintenance procedures may help avoiding unscheduled downtimes. Due to the planning and timely implementation of maintenance measures unnecessary, reactive work on plants and their unplanned shutdown may be avoided. Such preventive maintenance also helps in the continuous optimization of the maintenance and thus the manufacturing facility's operation.

Further exemplary method acts are described in FIG. 5. In act S5, one or more faulty transport devices may be based on the statistical characteristic. To that end, the statistical characteristic may be compared to a predetermined threshold in act S6. The predetermined threshold may be set by a user or may be calculated based on historical values of statistical characteristic. Accordingly, the sequence for maintaining the transportation devices may be based on the faulty transportation devices or the sequence for maintaining may be used for identifying the faulty transportation devices, e.g., the ones exceeding the predetermined threshold.

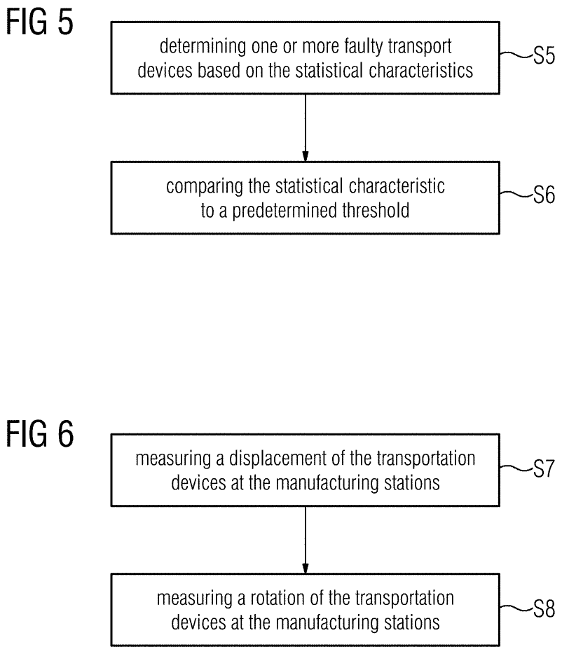

In FIG. 6, further exemplary method acts are shown. In act S7, a displacement of the transportation devices at the manufacturing stations, e.g., in relation to a reference system of the respective manufacturing stations is measured. Additionally, a rotation of the transportation devices at the manufacturing stations, e.g., in relation to a reference system of the respective manufacturing station is measured in act S8. Such measurements allow determining the pose of the transportation device and/or the workpiece in (each one of) the manufacturing station(s).

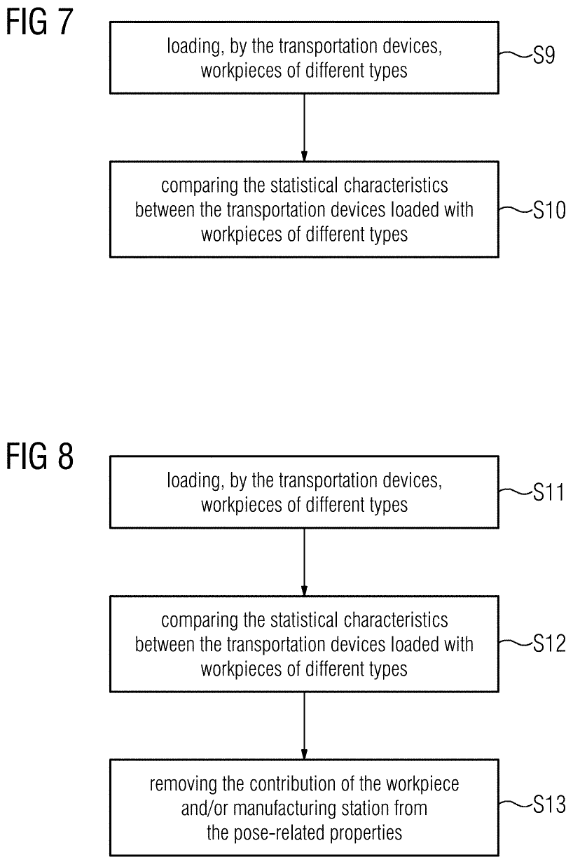

In FIG. 7, further exemplary method acts are shown. In act S9, one or more workpieces of different types may be loaded, by the transportation devices. As described, a workpiece of a specific type may loaded, (e.g., mechanically connected), to the transport device, for example, a sedan body with four doors and a hatchback. For example, one workpiece at a time may be loaded on the transportation device. Subsequently, a workpiece of a different type may be loaded onto the same transportation device, e.g., to process the workpiece according to their type. Different processing operations may be performed on the workpiece depending on the type of the workpiece. To that end, however, the same transportation device may be used and/or the processing of the workpiece may be performed at the same manufacturing station or cell.

In act S10, the statistical characteristics between the transportation devices loaded with workpieces of different types may be compared. The result of the comparison may be used to determine a sequence for maintaining the one or more transportation devices, e.g., according to act S3 in FIG. 4.

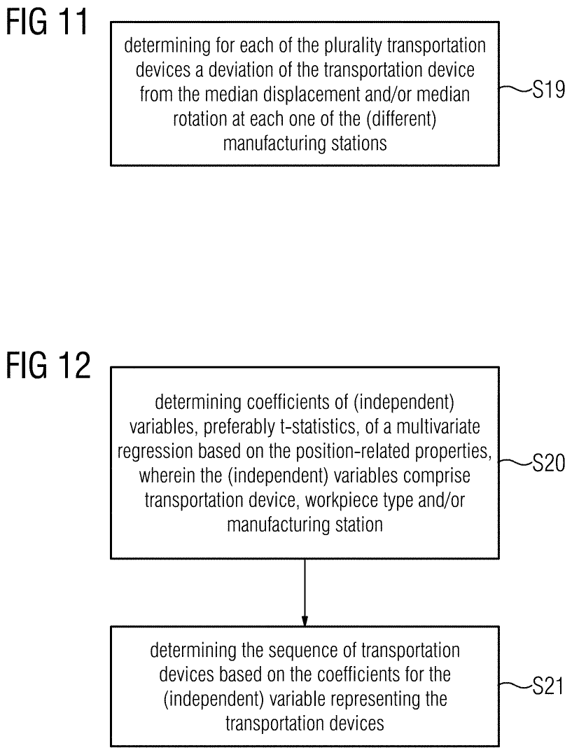

Further exemplary method acts are shown in FIG. 8. Here, as described in acts S9 and S10 of FIG. 7, different workpieces are loaded on the transportation devices and the statistical characteristics are compared in acts S11 and S12. In addition, the contribution of the workpiece and/or manufacturing station are removed from the pose-related properties. Each workpiece (or type of workpiece) may have an effect on the pose of the workpiece at a manufacturing station. Furthermore, the manufacturing station may have an effect on the pose of the workpiece. Still further, the transportation device may have effect on the pose of the workpiece at the manufacturing station. Now, in order to determine one or more defective transportation device and/or to determine a sequence for maintaining the transportation devices, the contribution of the workpiece (or type of workpiece) and the contribution of the manufacturing station are removed from the pose-related properties that are measured at a respective manufacturing station in act S13. For example, the median value or the mean value (of past or historic measurements of the workpiece (type) and/or manufacturing station) may be subtracted from the present measurement of the pose-related properties as will be described in the following, e.g., in connection with FIGS. 10 to 14. For example, the median value or mean value of the (past or historic) measurements of the pose-related properties of a workpiece (type), such as a car body of a Tiguan or Golf, at a first manufacturing station and/or at a second manufacturing station may be determined.

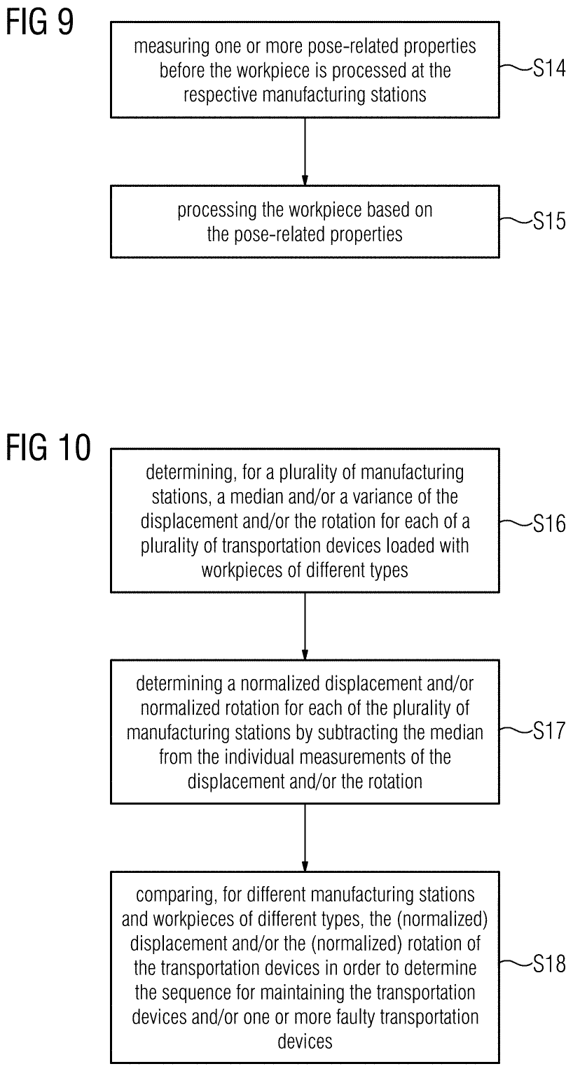

Turning to FIG. 9, the pose related properties of the one or more workpieces and/or transportation devices at the one or more manufacturing stations are measured. Thus, in act S14, the one or more pose-related properties are measured before the workpiece is processed at the respective manufacturing station(s). Thus, at each of the one or more manufacturing station the pose of the workpiece is determined. Subsequently, the workpiece is processed based on the pose-related properties in act S15. As explained in the above the pose related properties such as displacement and/or rotation of the workpiece may be used by one or more robots at the manufacturing station to process the workpiece, e.g., apply paint to the workpiece. Hence, the pose-related properties that are determined for processing the workpiece may also be used for determining a sequence for maintaining the one or more transportation devices.

In FIG. 10, further exemplary method acts are shown. In act S16, a median and/or a variance of the displacement and/or the rotation for each of a plurality of transportation devices loaded with workpieces of different types is determined for a plurality of manufacturing stations. That is, at each of a plurality of manufacturing stations displacement and/or rotation of a workpiece and/or the transportation device is determined. This may be performed for workpiece of the same type and for workpieces of different types.

In act S17, a normalized displacement and/or normalized rotation for each of the plurality of manufacturing stations is determined, for example, by subtracting the median from the individual measurements of the displacement and/or the rotation at a manufacturing station.

Then, in act S18, the (e.g., normalized) displacement and/or the (e.g., normalized) rotation of the transportation devices is compared in order to determine the sequence for maintaining the transportation devices and/or one or more faulty transportation devices. The comparison of the (e.g., normalized) displacement and/or the (e.g., normalized) rotation of the transportation devices may be compared between different manufacturing stations and/or workpieces of different types. As a result of the comparison a sequence for maintaining the transportation devices may be obtained by ordering the transportation devices according to a deviation from the median and/or variance in ascending or descending order.

Turning to FIG. 11, act S19 is shown according to which a deviation of the transportation device from the median displacement and/or median rotation at each one of the (e.g., different) manufacturing stations is determined. The deviation of the pose-related properties may thus be determined between the individual or current measurement(s) at the manufacturing station(s) and the median of the pose-related properties at (all of) the manufacturing stations. Hence, a comparison according to act S18 may be performed according to act S19.

In FIG. 12, additional or alternative method acts 20, 21 are shown for determining a statistical characteristic for each of the plurality of transportation devices based on the pose-related properties. In act S20, coefficients of (e.g., independent) variables, (e.g., t-statistics), of a multivariate regression based on the position-related properties, are determined, wherein the (e.g., independent) variables include transportation device, workpiece type, and/or manufacturing station. The dependent variable of the multivariate regression may be a variable representing the pose of the car body and/or the transportation device.

In act S20, the sequence of transportation devices is determined based on the coefficients for the (e.g., independent) variable representing the transportation devices. As before, the sequence may be determined by ordering the coefficients in an ascending or descending order according to their value.

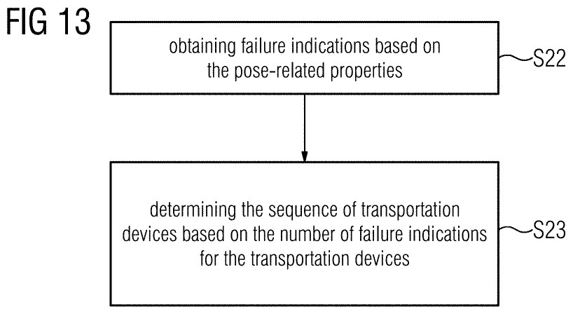

In FIG. 13, additional or alternative method acts 22, 23 are shown for determining a sequence of transportation device to be maintained. In act S22, failure indications based on the pose-related properties are obtained. The failure indication may be obtained from a camera system or other sensor system of the manufacturing station which measures the pose-related properties. In case the pose exceeds one or more predetermined thresholds of rotation and/or displacement, a corresponding failure indication may be created. The failure indication may be used to determine the optimal sequence of maintenance. Thus, in act S23, the sequence of transportation devices may be determined based on the number of failure indications for the transportation devices.

Similarly to the embodiment of FIG. 12, a regression based on the (e.g., independent) variables transportation device, workpiece type and/or manufacturing station may be performed. The dependent variable of the regression may be the failure indication(s) in that case (instead of the pose). Thus, the regression in that case may be a logistic regression.

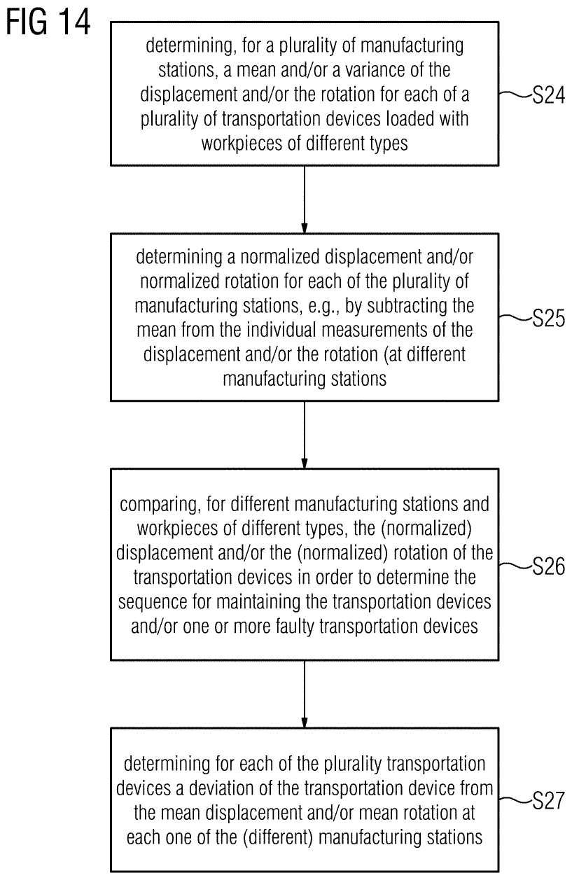

In FIG. 14, additional or alternative method acts 22, 23 are shown for determining a statistical characteristic are shown. In act S24, a mean and/or a variance of the displacement and/or the rotation for each of a plurality of transportation devices loaded with workpieces of different types are determined, for a plurality of manufacturing stations.

In act S25, a normalized displacement and/or normalized rotation for each of the plurality of manufacturing stations, e.g., is determined by subtracting the mean from the individual measurements of the displacement and/or the rotation (e.g., at different manufacturing stations).

In act S26, the (e.g., normalized) displacement and/or the (e.g., normalized) rotation of the transportation devices are compared, for different manufacturing stations and workpieces of different types, in order to determine the sequence for maintaining the transportation devices and/or one or more faulty transportation devices.

The act S26 may include act S27, wherein a deviation of the transportation device from the mean displacement and/or mean rotation at each one of the (e.g., different) manufacturing stations is determined for each of the plurality transportation devices.

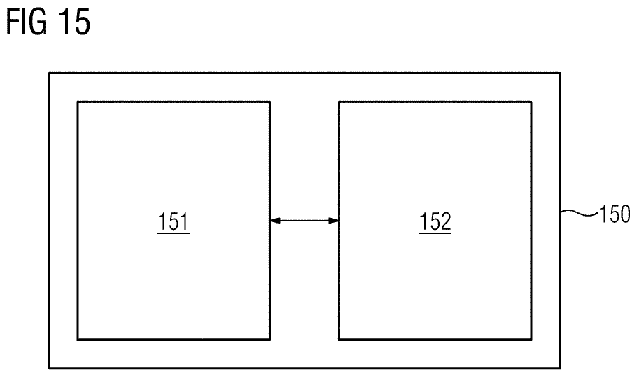

In FIG. 15, an apparatus 150 including a processor 151 and a memory 152 is shown. The apparatus 150 is operative to perform the method acts of any one of the preceding embodiments, e.g., as described in connection with FIGS. 4 to 14. To that end, the memory 152 may include instruction in form of program code that may be executed by the processor 151. The instruction may implement the acts as described in the embodiments before, in particular in connection with FIGS. 4 to 14.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of maintaining a transport system in a manufacturing facility, the method comprising:
measuring one or more pose-related properties of a plurality of transportation devices at a plurality of manufacturing stations in the manufacturing facility, at which manufacturing stations one or more workpieces are processed;
determining a statistical characteristic for each transportation device of the plurality of transportation devices based on the one or more pose-related properties;
loading, by the plurality of transportation devices, workpieces of different types, workpieces of different car types, different geometry, sizes, weight, different suspension point, and/or loading position on the transportation devices;
comparing the statistical characteristics between the plurality of transportation devices loaded with workpieces of different types at a same manufacturing station and/or at different manufacturing stations by removing a contribution of the workpiece and/or manufacturing station from the pose-related properties; and
determining a sequence for maintaining one or more transportation devices of the plurality of transportation devices based on the comparison of the statistical characteristics; and
optionally performing one or more maintenance procedures based on the sequence.

2. The method of claim 1, further comprising:
determining one or more faulty transportation devices of the plurality of transportation devices by comparing the statistical characteristic to a predetermined threshold.

3. The method of claim 1, further comprising:
measuring a displacement of the plurality of transportation devices at the plurality of manufacturing stations in relation to a reference system of a respective manufacturing station; and/or
measuring a rotation of the plurality of transportation devices at the plurality of manufacturing stations in relation to a reference system of a respective manufacturing station.

4. The method of claim 1, further comprising:
measuring one or more pose-related properties before the workpiece is processed at the respective manufacturing stations; and
processing the workpiece based on the pose-related properties.

5. The method of claim 1, further comprising:
determining, for the plurality of manufacturing stations, a median and/or a variance of a displacement and/or a rotation for each transportation device of the plurality of transportation devices loaded with workpieces of different types.

6. The method of claim 1, further comprising:
determining a normalized displacement and/or normalized rotation for each manufacturing station of the plurality of manufacturing stations by subtracting a median from individual measurements of a displacement and/or a rotation at different manufacturing stations.

7. The method of claim 6, further comprising:
comparing, for different manufacturing stations and workpieces of different types, the normalized displacement and/or the normalized rotation of the transportation devices in order to determine the sequence for maintaining the plurality of transportation devices and/or one or more faulty transportation devices of the plurality of transportation devices.

8. The method of claim 1, further comprising:
determining, for each transportation device of the plurality transportation devices, a deviation of the respective transportation device from a median displacement and/or median rotation at each manufacturing station of the plurality of manufacturing stations.

9. The method of claim 1, further comprising:
determining coefficients of independent variables, preferably t-statistics, of a multivariate regression based on the pose-related properties, wherein the independent variables comprise transportation device, workpiece type, and/or manufacturing station.

10. The method of claim 9, further comprising:
determining the sequence of the plurality of transportation devices based on the coefficients for the independent variables representing the plurality of transportation devices.

11. The method of claim 1, further comprising:
obtaining failure indications based on the pose-related properties; and
determining the sequence of the plurality of transportation devices based on a number of failure indications for the plurality of transportation devices.

12. The method of claim 1, further comprising:
determining, for the plurality of manufacturing stations, a mean and/or a variance of a displacement and/or a rotation for each transportation device of the plurality of transportation devices loaded with workpieces of different types.

13. The method of claim 1, further comprising:
determining a normalized displacement and/or normalized rotation for each manufacturing station of the plurality of manufacturing stations by subtracting a mean from individual measurements of a displacement and/or a rotation at different manufacturing stations.

14. The method of claim 13, further comprising:
comparing, for the different manufacturing stations and workpieces of different types, the normalized displacement and/or the normalized rotation of the plurality of transportation devices in order to determine the sequence for maintaining the plurality of transportation devices and/or one or more faulty transportation devices of the plurality of transportation devices.

15. The method of claim 1, further comprising:
determining, for each transportation device of the plurality transportation devices, a deviation of the respective transportation device from a mean displacement and/or mean rotation at each manufacturing station of the plurality of manufacturing stations.

16. An apparatus comprising:
a processor; and
a memory,
wherein the processor and the memory are configured to:
measure one or more pose-related properties of a plurality of transportation devices at a plurality of manufacturing stations in a manufacturing facility, at which manufacturing stations one or more workpieces are processed;
determine a statistical characteristic for each transportation device of the plurality of transportation devices based on the one or more pose-related properties;
load workpieces of different types, workpieces of different car types, different geometry, sizes, weight, different suspension point, and/or loading position on the transportation devices;
compare the statistical characteristics between the plurality of transportation devices loaded with workpieces of different types at a same manufacturing station and/or at different manufacturing stations by removing a contribution of the workpiece and/or manufacturing station from the pose-related properties; and
determine a sequence for maintaining one or more transportation devices of the plurality of transportation devices based on the comparison of the statistical characteristics; and
optionally perform one or more maintenance procedures based on the sequence.

17. A non-transitory computer program product comprising program code and configured to be stored on an apparatus, that when executed by a processor of the apparatus, causes the apparatus to:
measure one or more pose-related properties of a plurality of transportation devices at a plurality of manufacturing stations in a manufacturing facility, at which manufacturing stations one or more workpieces are processed;
determine a statistical characteristic for each transportation device of the plurality of transportation devices based on the one or more pose-related properties;
load workpieces of different types, workpieces of different car types, different geometry, sizes, weight, different suspension point, and/or loading position on the transportation devices;
compare the statistical characteristics between the plurality of transportation devices loaded with workpieces of different types at a same manufacturing station and/or at different manufacturing stations by removing a contribution of the workpiece and/or manufacturing station from the pose-related properties; and
determine a sequence for maintaining one or more transportation devices of the plurality of transportation devices based on the comparison of the statistical characteristics; and
optionally perform one or more maintenance procedures based on the sequence.
